(19) United States
(12) Patent Application Publication
(10) Pub. No.: US 2021/0092940 A1
(43) Pub. Date: Apr. 1, 2021

(54) UNIFORM POULTRY FEEDING SYSTEM

(71) Applicants: Wei-Cheng KUO, Taichung City (TW); Shu-Mei Hung, Brooklyn, NY (US)

(72) Inventor: Wei-Cheng KUO, Taichung City (TW)

(21) Appl. No.: 16/634,450

(22) PCT Filed: Jul. 27, 2017
(86) PCT No.: PCT/IB2017/054591

§ 371 Date: Jan. 27, 2020

(51) Int. Cl. A01K 39/014; A01K 39/012

(52) U.S. Cl. CPC A01K 39/014; A01K 39/0125

(57) ABSTRACT

The present invention provides a uniform poultry feeding system that is comprised of a trough and a fodder conveyor unit. The trough consists of a pair of trough bodies and a fencing. The fodder conveyor unit is installed above the trough and has a conveyor being set between the trough bodies and the fencing, a slot at the bottom to enable fodder falling into the trough bodies, several stopcocks fixed onto the pipe, several suspension cables extending and connecting to the stopcocks to control the rise and fall of the stopcocks and the conveyor by moving up and down, prevent rotation of the pipe and displacement of the slot and adjust the discharge of fodder into the trough bodies by changing the distance between the conveyor and the bottom of the trough bodies.

### BACKGROUND OF INVENTION

### 1. Field of the Invention

The present invention relates generally to a poultry feeding equipment, and more particularly to a uniform poultry feeding system.

### 2. Description of Related Art

The earlier feeding systems of poultry farms are usually comprised of multiple feeders and feeding pipes respectively connecting to the feeders so that fodder can be conveyed through each feeding pipe to the corresponding feeder to feed poultry. Although the above-mentioned feeding systems can meet the end of feeding large quantity of poultry, since the poultry tends to fall over one another to get fed, some will fail to squeeze their ways to feeders or have less intake. Therefore, the above-mentioned feeding systems cannot assure the feeding quality of equal intake among poultry.

To overcome the above-mentioned shortcomings, some practitioners have developed long feeding systems called troughs, which can be generally divided into two types. The first type of trough is as shown in the U.S. Pat. No. 7,753,001, which has a conveyor belt installed in the trough for conveyance of fodder and a lifting shield above the trough used for covering the trough during the process of the conveyor belt delivering and filling fodder into the trough and poultry is prevented to approach to the trough till it is filled with fodder and the shield is lifted. In this way, the poultry at both sides of the trough can be fed with equal quantity of fodder at the same time, ensuring the same feeding quality of poultry. The other type is as shown in the Patent Application Publication No. WO2013/028067, which has no conveyor belt installed in the trough as the former does and yet, a conveyor element is installed in a pipe above the trough and a plurality of fodder outlets are set at the bottom of the pipe so that fodder can be moved in the pipe with the conveyor element and fall into the trough when arriving at the fodder outlets. Besides, the pipe of the second type of trough is able to rise and fall and cover the trough as the former invention in order to prevent poultry from stretching their heads to the trough.

Fodder can be continuously filled into the trough described in the above-mentioned U.S. Pat. No. 7,753,001 whereas the fodder outlets are separately set at the bottom of the pipe of the trough provided in the Patent Application Publication No. WO2013/028067. Obviously, the former can produce better outcomes in terms of ensuring equal intake of poultry at both sides of the trough. However, because the conveyor belt of the U.S. Pat. No. 7,753,001 is installed in the trough, compared to the conveyor element set in the pipe of the Patent Application Publication No. WO2013/028067, the assembly, clearing and maintenance procedures are relatively complicated.

On that basis, the inventor, in the spirit of constantly striving for perfection, has made continuous attempts and eventually comes up with this invention.

### SUMMARY OF THE INVENTION

The present invention mainly aims to provide a uniform poultry feeding system that ensures equal intake of poultry through uniform distribution and stable conveyance of fodder. In addition, the discharge of fodder is adjustable, showing greater flexibility and higher practical value of feeding poultry.

To meet this end, the present invention provides a uniform poultry feeding system comprised of a trough, including a pair of trough bodies with multiple concaves facing upward designed for filling fodder, a fencing mounted above the trough bodies, and multiple feeding outlets connecting to the trough bodies; a fodder conveyor unit installed above the body with the conveyor being set between the body and the fencing; a pipe and a shifting part in the pipe with the pipe corresponding to a slot at the bottom of the body of the trough and the shifting part used for carrying fodder along the pipe till the fodder falls into the trough bodies from the slot; several stopcocks fixed on the pipe; several suspension cables connecting to the stopcocks from top to bottom.

### BRIEF DESCRIPTION OF THE DRAWINGS

FIG. 1 is an assembly stereogram of a preferred embodiment of the present invention.

FIG. 2 is a side view of a preferred embodiment of the present invention, which describes the situation of fodder falling into the trough.

FIG. 3 is an end view along the conveyor slot of a preferred embodiment of the present invention, which describes the situation of fodder falling into the trough.

FIG. 4 is another side view of a preferred embodiment of the present invention, which describes the situation of fodder falling into the trough.

FIG. 5 is another end view along the conveyor slot of a preferred embodiment of the present invention, which describes the situation of fodder falling into the trough.

### DETAILED DESCRIPTION OF THE INVENTION

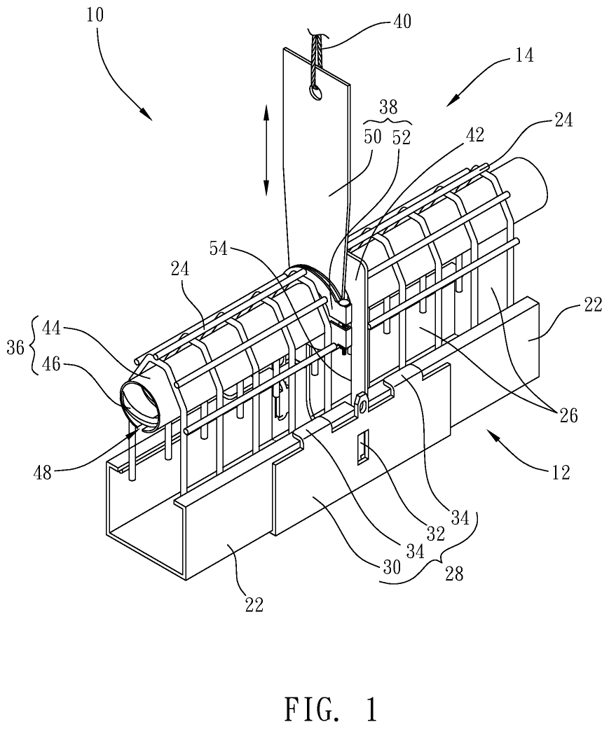

First of all, as shown in FIG. 1, the uniform poultry feeding system 10 is a preferred embodiment of the present invention, which is comprised of a trough 12 and a fodder conveyor unit 14.

The trough 12 consists of a body 22 with a plurality of concaves up and a fencing 24 installed above the trough bodies 22 with the fencing 24, as a latticed structure, having multiple feeding outlets 26 connecting to the trough bodies 22 connected as a whole with multiple joining-up parts 28 made of metal sheet and comprised of a “U” shaped frame 30 and two connecting holes 32 on both sides of the frame 30 by stamping and in the shape of tab and having openings at both ends, designed for insertion and fixation of the ends of the two trough bodies 22 into the frame 30, and a pair of fastenings 34 being bent and used as the top rims of the frame 30 standing opposite to each other to fasten the top rims of the two trough bodies 22 of the frame 30.

The fodder conveyor unit 14 is installed above the trough 12 and comprised of a conveyor 36, a plurality of stopcocks 38, a plurality of suspension cables 40 and a plurality of limiters 42. The conveyor 36 consists of a pipe 44 and a shifting part 46 installed in the pipe 44 with the pipe 44 being set between the trough bodies 22 and the fencing 24 and connecting to a commonly used fodder conveyor equipment (which is not shown in FIG. 1) having an axially extending slot 48 corresponding to the trough bodies 22 at the bottom and the shifting part 46 being a commonly used spiral part of fodder conveyor used for carrying fodder along the pipe 42 by rotation so that the fodder falls into the trough bodies 22 through the slot 48. Each stopcock 38 has a body 50 and a fastening 52 with the body 50 in the shape of a sheet connecting to a suspension cable 40 at the top and having a fastening 52 at the bottom, the fastening 52 being a commonly used detachable pipe hoop used for fastening the pipe 42 and the suspension cables 40 being the commonly used steel cables. No detailed description of the structure of such parts and components as capstan and motor used for furling or releasing the steel cables are provided since it is not the key technology of the present invention. The structure is generally designed for furling and releasing the suspension cables 40 to enable rise and fall of the pipe 42, which can be controlled with the suspension cables 40 and stopcocks 38. The limiters 42 are several pieces of sheets to be inserted into the frame 30 between the two trough bodies 32, above which, there is a limit space 54, which is practically a slot slightly larger than the outer diameter of the pipe 44 in width, enabling the conveyor 36 passing through the pipe 44 without shaking.

The mode of operation, characteristics and functions of the uniform poultry feeding system 10 of the present invention are hereby given as follows:

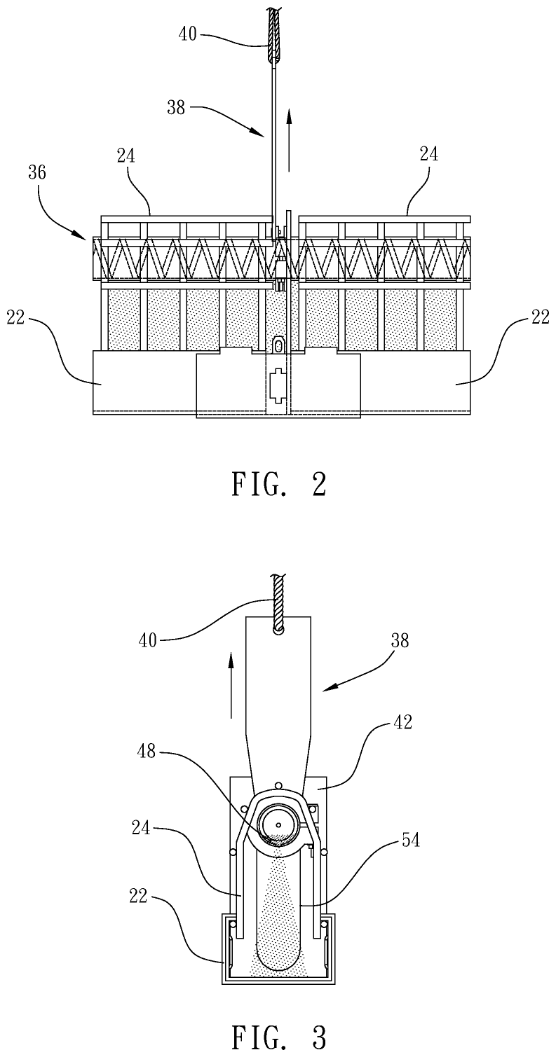

When feeding poultry (e.g. chicken, duck and goose), fodder is pushed by the shifting part 46 and moves in the pipe 44 and falls into the trough bodies 22 through the slot 48. As shown in FIGS. 2 and 3, because the axially extending slot 48 is installed at the bottom of the pipe 44, the trough bodies 22 can be evenly filled with fodder, which ensures equal intake of poultry and overcomes the shortcoming of the commonly used design of separate feeding outlets that fails to realize equal intake of poultry. When the conveyance of fodder stops, poultry on both sides of the trough 12 can be fed by stretching their heads into the trough bodies 22 through the feeding outlets 26 of the fencing 24. After that, the suspension cables 40's decline, during which process, the conveyor 36 gradually falls into the trough bodies 22 to prevent the poultry from continuously stretching their heads to the trough bodies 22, enabling the uniform and synchronous feeding and synchronously withholding fodder from poultry.

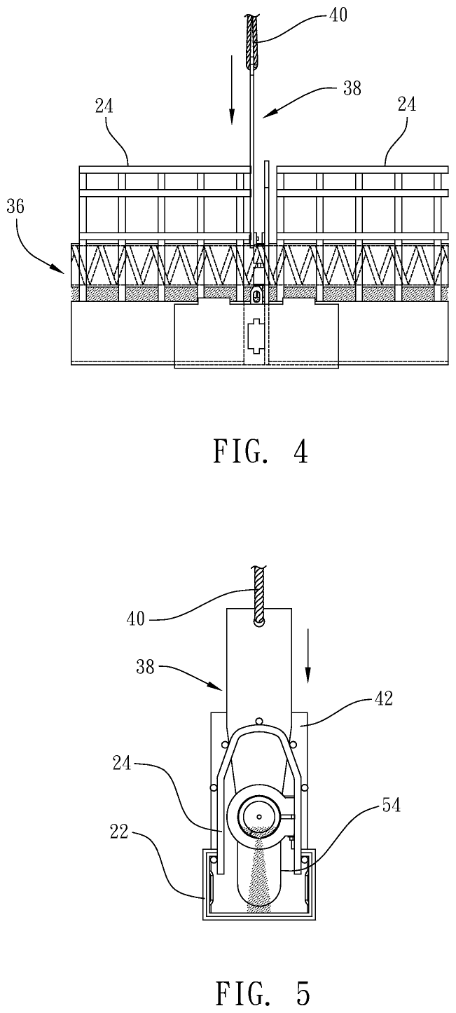

Particularly, as shown in FIGS. 4 and 5, when the conveyor 36 declines, because the slot 48 is close to the trough bodies 22, the area of spilling fodder from the slot 48 is smaller than that as shown in Figure XX and the accumulated fodder is also less. Hence, there is less discharge of fodder. In other words, the present invention features in adjusting the discharge of fodder by changing the position of the conveyor 36 and the distance between the pipe 44 and the trough bodies 22.

Secondly, the stopcocks 38 can rise and fall as driven by the suspension cables 40 and prevent the pipe 44 from rotation and the slot 48 from displacement, creating a stable discharge condition of fodder with the conveyor 36.

From the foregoing, the uniform poultry feeding system provided by the present invention not only ensures equal intake of poultry through uniform distribution and conveyance of fodder with the slot at the bottom of the pipe, but also enables adjustments to discharge of fodder through rise and fall of the stopcocks and suspension cables, showing greater flexibility of feeding poultry. Moreover, the stopcocks and suspension cables can prevent rotation of the pipe and displacement of the slot and thereby makes the conveyance of fodder with the conveyor more stable, showing considerable practical value.

What is claimed is:

1. A uniform poultry feeding system, which is comprised of:
a pair of trough bodies with multiple concaves facing upward designed for filling fodder, a fencing mounted above the trough bodies, and multiple feeding outlets connecting to the trough bodies; and
a fodder conveyor unit installed above the body with the conveyor being set between the body and the fencing; a pipe and a shifting part in the pipe with the pipe corresponding to a slot at the bottom of the body of the trough and the shifting part used for carrying fodder along the pipe till the fodder falls into the trough bodies from the slot; several stopcocks fixed on the pipe; several suspension cables connecting to the stopcocks from top to bottom, designed for controlling the rise and fall of the stopcocks and the pipe by moving up and down and preventing rotation of the pipe and displacement of the slot.

2. The system defined in claim 1, wherein the fodder conveyor unit is comprised of several limiters installed in the trough having a conveyor corresponding to the limit space to prevent the conveyor from shaking.

3. The system defined in claim 2, wherein the limiters are pieces of sheet to be inserted into the trough bodies, the limit space being a slot for the conveyor to pass through the limit space slightly larger than the outer diameter of the pipe in width.

4. The system defined in claim 1, wherein there is a slot axially extending along the pipe.

5. The system defined in claim 1, wherein there is a slot axially extending along the pipe.

6. The system defined in claim 5, wherein the body is a plate connecting to a pipe hoop as the fastening.

7. The system defined in claim 5, wherein the suspension cables are steel cables.

8. The system defined in claim 3, wherein the trough is comprised of a pair of trough bodies connected with multiple joining-up parts consisting of a frame and two connecting holes on both sides of the frame for insertion and fixation of the ends of the two trough bodies, and a pair of fastenings standing opposite to each other on the frame to fasten the trough bodies inserted into the frame with the limiters inserted between the ends of the two trough bodies.
